(19) United States
(12) Patent Application Publication
(10) Pub. No.: US 2009/0068327 A1
(43) Pub. Date: Mar. 12, 2009

(54) Food stuffing insertion tool and method of use

(76) Inventor: Vincent D. Iglesias, Rochester, WA (US)

Correspondence Address: JAMES RAY & ASSOCIATES, 2640 PITCAIRN ROAD, MONROEVILLE, PA, 15146, US

(21) Appl. No.: 12/283,554

(22) Filed: Sep. 12, 2008

Related U.S. Application Data
(60) Provisional application No. 60/971,604, filed on Sep. 12, 2007.

(51) Int. Cl. A47J 43/16

(52) U.S. Cl. 426/281; 99/345; 99/494

(57) ABSTRACT

An insertion tool for food preparation includes an elongated substantially planar cover having arcuate lateral edges, a gripping means fixedly attached at one end of this cover member for the purposes of holding, inserting, and removing the insertion tool, and a rigid trough member having one beveled end and flared lateral edge flanges slidingly engageable with the arcuate lateral edges of the cover member. An optional part of the tool is an end cap having at least one sharp edge and removably disposed on the beveled end of the trough member.

### CROSS REFERENCE TO RELATED APPLICATION

This patent application is related to and claims priority from U.S. Provisional Patent Application Ser. No. 60/971,604 filed Sep. 12, 2007.

### FIELD OF THE INVENTION

The present invention relates, in general, to food preparation devices and, more particularly, this invention relates to kitchen tools for imbedding spices and stuffing inside meat and other such items, typically prior to cooking.

### BACKGROUND OF THE INVENTION

Prior to the conception and development of the present invention, those preparing food, such as meats, typically place spices, marinades, and sauces on the exterior. This only flavors a small portion of the food, and much is often entrained away by juices and fats oozing out. Liquids such as brine and marinades can be injected into food with devices somewhat like hypodermic needles and syringes. Two syringe-like devices are disclosed in U.S. Pat. Nos. 6,117,467 and 6,578,470. At least two such devices are commercially available, the Flavor Express Marinator and the Ronco Solid Flavor Injector, and both were evaluated in the May/June 2005 Cook's Illustrated magazine. With one they experienced a problem of the stuffing clogging the outlet, and with the other, loading the ingredients into the syringe was both tedious and time-consuming. These are drawbacks that the present invention will overcome.

In U.S. Pat. No. 2,124,700, Hartzell discloses what he calls a larding needle for inserting various fatty substances into lean meats. It has two separable semi-cylindrical sections, but they do not securely slide together. The Hartzell device does not have an end cap, so the section containing the ingredients can only be removed in one direction, which means trying to grasp and pull the slimy end of it. Also, there is no mention of how the contained ingredients are held in place as the tube is pulled out.

### SUMMARY OF THE INVENTION

The present invention provides an insertion tool for food preparation and includes an elongated substantially planar cover having arcuate lateral edges and a gripping means fixedly attached at one end of this cover member for the purposes of holding, inserting, and removing the insertion tool. Additional parts of the tool are a rigid trough member having one beveled end and flared lateral edge flanges slidingly engageable with the arcuate lateral edges of the cover member, and an optional end cap having at least one sharp edge and removably disposed on the beveled end of the trough member.

In an alternative embodiment of the present invention, the mating edges are switched as to on which part they are located. A method of use is also disclosed.

### OBJECTS OF THE INVENTION

It is, therefore, one of the primary objects of the present invention to provide an economical yet effective device for inserting seasonings and stuffing inside meat and other food items.

Another object of the present invention is to provide an easy to load device for inserting solids and pastes inside larger food items.

Still another object of the present invention is to provide an inserter tool that is easy to load and yet readily deposits the desired substances along several inches inside a food item.

Yet another object of the present invention is to provide a food insertion channel that can be removed from either end of the food item into which it has been inserted while leaving essentially all the ingredients inside the food item.

An additional object of the present invention is to provide a insertion tool for food that can accommodate chunks as well as small granules of stuffing ingredients.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is an underside perspective view of the two main separated parts of the present invention.

FIG. 2 is a topside perspective view of the present invention loaded and ready for assembly.

FIG. 3 is a perspective view of the present invention depicted in an application.

FIG. 4 provides a perspective view of an alternative embodiment of the present invention.

FIG. 5 is a flow diagram of the preferred method for utilizing the insertion tool of the present invention.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

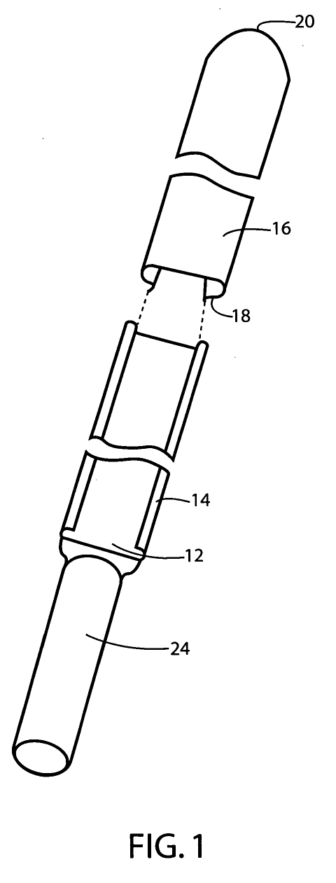

Referring initially to FIG. 1, this depicts the present invention in an underside perspective view of the two main separated parts. A cover 12 with a mating slide track 14 along both opposing lateral edges is fixedly attached to a gripping handle 24, which may be cylindrical or one of many other shapes. The holding channel or trough 16 has lateral opposing edges 18 that are bent or flanged to slidingly mate to tracks 14 on the cover piece 12. For the trough depicted, it has an essentially rectangular cross section for filling when viewing a plane perpendicular to the longitudinal axis. The tip 20 may be pointed or beveled, and sharp to facilitate penetrating into pieces of meat. Excluding the handle, the overall length is typically about five to twelve inches with about nine inches preferred. For a substantially rectangular trough 16, the cross section perpendicular to the longitudinal axis of the volume to be filled is preferably about one inch wide and half an inch high, but can be between one-quarter inch to one inch high and one half to 1.5 inches wide.

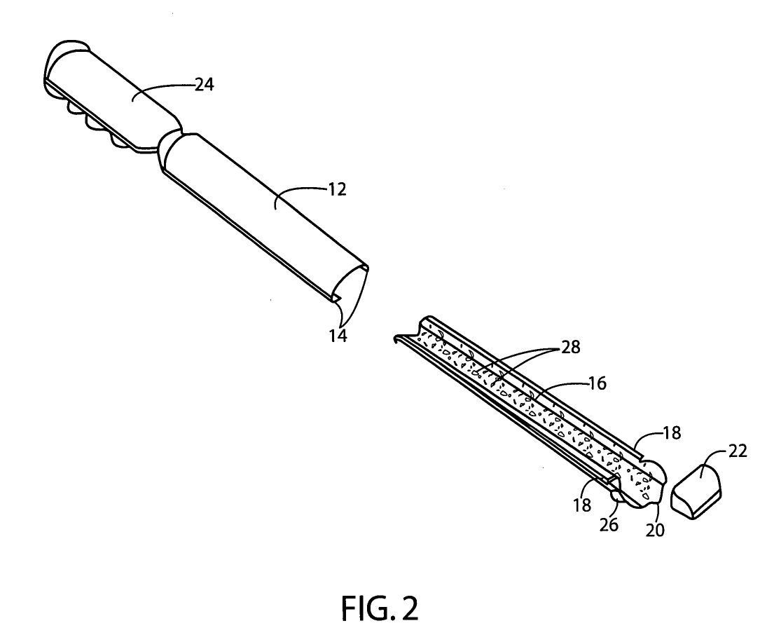

FIG. 2 is a topside perspective view of the present invention loaded and ready for assembly. The trough 16 can have either a rectangular or an oval cross section, as shown. The dimensions of the oval cross section will be in the range of one-half to 1.5 inch. With the handle 24 and cover part 12 removed, the trough 16 can be filled with seasonings and various types of stuffing 28 as desired. Preferably optional cap 22 is then snapped on the end 20 to hold the substances in place. Small protrusions or tabs 26 on the end of trough 16 aid in holding the end cap 22 in place. Alternatively, a friction fit will suffice. With some tip 20 designs, the cap 22 may not be necessary. The handle/cover combination, 24/12, can then be slid over the trough 16 by engaging track 14 with mating edge flanges 18. When the two are fully engaged, the end of the handle 24 closest to trough 16 substantially seals that end of the assembly and transfers pushing force to the trough 16.

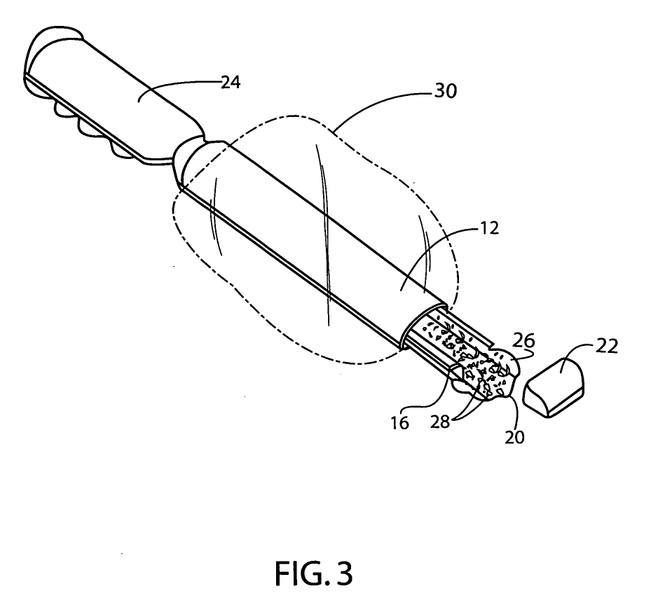

FIG. 3 is a perspective view illustrating the present invention inside a food item 30 after insertion and at the early stage of disengaging the cover 12. Spices and/or stuffing 28 are present all along the trough 16. After insertion, the cover 12 is slid off and out of the food or meat 30 with the aid of handle 24. If used, the optional end cap 22 is removed after insertion. The trough 16 can then be pulled out from either end while a finger or thumb is held against the contents 28 to keep them inside the food item 30. The removal can be aided by optional grasping tabs 26. The tabs 26 can serve the dual purpose of snapping on the end cap as well as for grasping that end. A ribbon of spices and/or stuffing is left behind as desired inside the food 30.

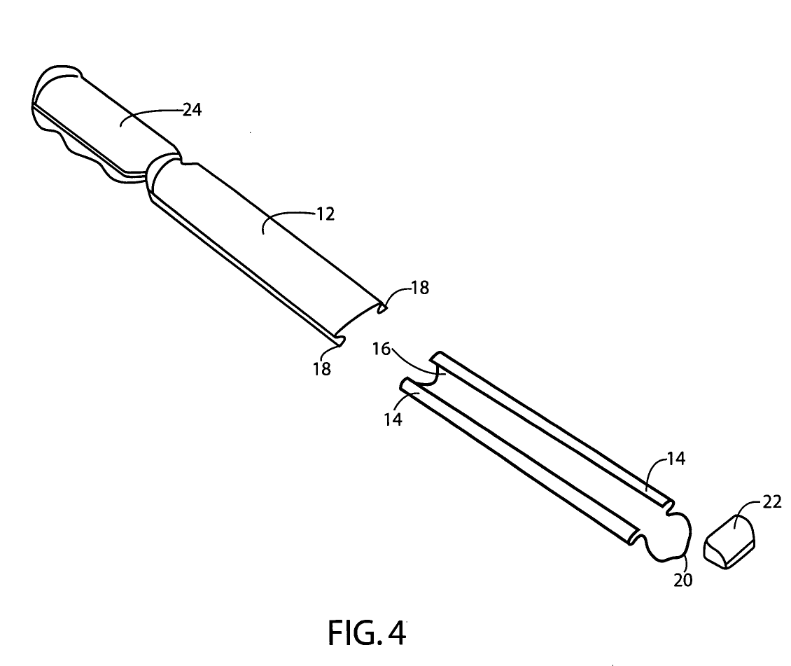

FIG. 4 provides a perspective view of an alternative embodiment of the present invention with interchanging of how the two main parts are constructed. It is much like that in FIG. 2, but in this instance the cover member 12 has the flared flanges 18 along the two opposing lateral edges such that they slide freely but securely inside the arcuate lateral edges 14 of the channel or trough 16. An optional cap 22 fits onto the beveled end 20 with a friction fit over the roughened outer surface at beveled end 20.

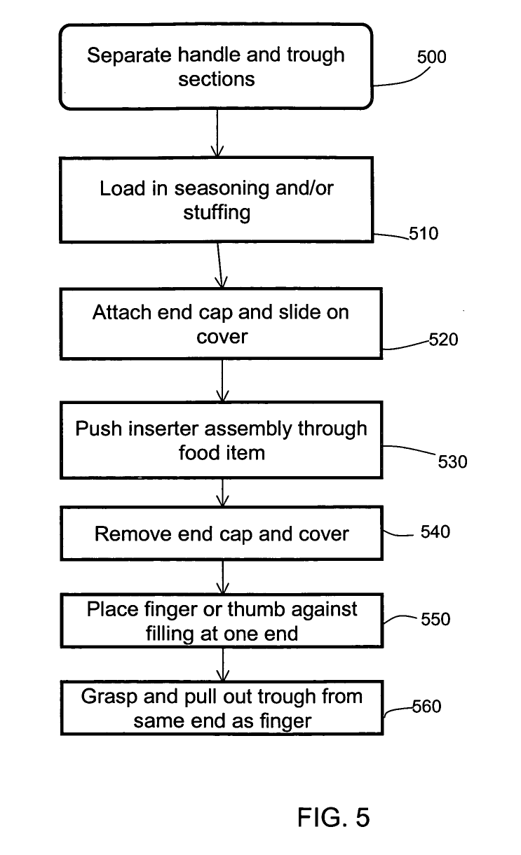

The preferred method of use is illustrated with the flow diagram in FIG. 5. Starting with step 500, the handle and trough sections are separated, if not already done. With the open end of the trough facing up, it is loaded with the desired stuffing, filling, and/or seasonings, 510. At step 520, preferably the end cap is secured and the cover slid over top of the trough. The open end of the trough butts up against the proximal end of the handle to seal and allow pushing force to be transferred. The assembly is then pushed through the food item, step 530, until the end cap comes out the other side. At step 540, the end cap and handle/cover are removed. A finger or thumb is then placed at either end to retain the filling material in place, step 550. Finally, the end of the trough next to the holding finger is pulled out while the ribbon of internal material stays essentially in place, step 560. The food item can then be finished as specified.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

What is claimed is:

1. An insertion tool for food preparation comprising:
a) an elongated substantially planar cover member of a first predetermined length having arcuate lateral edges;
b) a gripping means fixedly attached at one end of said cover member for the purposes of holding, inserting, and removing said insertion tool; and
c) a rigid trough member with a preselected cross-sectional shape and having a predetermined width, height, and a second predetermined length, said trough member having one beveled end and flared lateral edge flanges slidingly engageable with said arcuate lateral edges of said cover member.

2. The insertion tool, according to claim 1, wherein said first predetermined length of is between about five and twelve inches.

3. The insertion tool, according to claim 1, wherein said preselected cross section shape of said trough member is substantially three sides with two being parallel to one another.

4. The insertion tool, according to claim 1, wherein said preselected cross sectional shape is substantially oval with a truncated apex.

5. The insertion tool, according to claim 1, wherein said second predetermined length of is about one half to two inches longer than said first predetermined length.

6. The insertion tool, according to claim 1, wherein said predetermined width of is between about one half and two inches.

7. The insertion tool, according to claim 1, wherein said predetermined height is between about one quarter and 1.5 inches.

8. The insertion tool, according to claim 1, wherein said gripping means is a substantially cylindrical handle.

9. The insertion tool, according to claim 1, wherein said beveled end of said trough member has a removably attached end cap.

10. An insertion tool for food preparation comprising:
a) an elongated substantially planar cover member of a first predetermined length having flared lateral edge flanges;
b) a gripping means fixedly attached at one end of said cover member for the purposes of holding, inserting, and removing said insertion tool; and
c) a rigid trough member with a preselected cross-sectional shape and having a predetermined width, height, and a second predetermined length, said trough member having one beveled end and arcuate lateral edges slidingly engageable with said flared lateral edge flanges on said cover member.

11. The insertion tool, according to claim 10, wherein said second predetermined length at a longest point is about one half to two inches longer than said first predetermined length.

12. The insertion tool, according to claim 10, wherein said predetermined width is between about one half and two inches.

13. The insertion tool, according to claim 10, wherein said predetermined height is between about one quarter and 1.5 inches.

14. The insertion tool, according to claim 10, wherein said beveled end of said trough member has a removably attached end cap.

15. A method of inserting seasonings and stuffings into food items, said method comprising:
a) sliding apart a cover member connected to a handle and a trough member, wherein each member has opposing lateral edges mating with lateral edges on other said member;
b) filling said trough member with at least one of seasonings and stuffing;
c) covering said trough with said handle/cover member by sliding together mating lateral edges;
d) pushing said insertion tool into a target food item until said end cap protrudes from an opposite side;
e) removing said end cap;
f) sliding said handle/cover member back and out of said food item;
g) grasping an end of said trough member;
h) holding a finger against said at least one of stuffing and seasoning; and
i) pulling out said trough member away from said holding finger until said trough is completely removed.

16. The method of inserting seasonings and stuffings into food items, according to claim 15, further including the step of attaching an end cap over a beveled end of said trough member, after filling said tough member and before covering said trough with said handle/cover means.
